(19) United States
(12) Patent Application Publication
(10) Pub. No.: US 2009/0291595 A1
(43) Pub. Date: Nov. 26, 2009

(54) Interconnection module

(76) Inventor: Luis Alberto Ruiz De Olano, Cordoba (AR)

Correspondence Address: LUIS ALBERTO RUIZ DE OLANO, WILSON 1694, CORDOBA, CORDOBA, 5012, AR

(21) Appl. No.: 12/382,759

(22) Filed: Mar. 24, 2009

(30) Foreign Application Priority Data
May 22, 2008 (AR) 20080102164

(51) Int. Cl. H01R 13/46

(52) U.S. Cl. 439/625

(57) ABSTRACT

This invention, called Interconnection Module, has its origins in the Ornamental Electrical Molding (U.S. Pat. No. 5,367,122). The Ornamental Electrical Molding results from combining the electrical functions of the architectural cables with the ornamental features of the architectural moldings. This combination makes the Ornamental Electrical Molding a necessary complement to both types of products. This complementarity requires that this system for electrical exposed installations adjusts its design to the various current architectural styles, a situation that demands a great variety of models.

The Interconnection Module, object of this patent, has its origins in this adjustment, and it arises as the element that allows systematizing the standard and non-standard parts of the group. Thus, the Interconnection Module is the main factor that controls the product as a whole, becoming the key that lead all the designs of the Ornamental Electrical Molding.

### CROSS-REFERENCE TO RELATED APPLICATION:

The related patent with the Interconnection Module object of this new application is the U.S. Pat. No. 5,367,122 registered in the United States in Nov. 22, 1994, which claims the rights to the Ornamental Electrical Molding.

Interconnection Module Prior Application:

Prior application number: 20080102164

Filling date: May 22, 2008

Country: Argentina

### STATEMENT REGARDING FEDERALLY SPONSORED RESEARCH OR DEVELOPMENT

“Not Applicable”

### REFERENCE TO SEQUENCE LISTING, A TABLE OR A COMPUTER PROGRAM LISTING COMPACT DISC APPENDIX

“Not Applicable”

### BACKGROUND OF THE INVENTION

This invention refers to conductor systems of electric current and, in particular, to surface conductor systems that have self-fixing means and that are adapted either for exposed installations made in preexisting structures or for applications where the possibility for frequent changes in the needs of urban electrical services is considered.

The Ornamental Electrical Molding U.S. Pat. No. 5,367,122 as a product is a system that consists of both the Electrical Molding itself as the main component, and of a secondary subsystem consisting of the Connectors and the Electrical Fittings.

The Electrical Molding in itself is a type of cable that is designed to adopt ornamental shapes. It results from combining the electrical functions of the cables and the ornamental features of the moldings. The Connectors are the constituent components that facilitate the joints, the diversions, or the branches among the different sections of the Molding. The Electrical Fittings are devices that expand the specific functions of the product, for instance, switches, sockets, lamp sockets, Jack RJ11, etc.

The subsystem of Connectors and Electrical Fittings will be henceforth referred to as Complementary Components. In this way, the “Complementary Components” refer to either the system of these components or some of them (Connectors and/or Accessories). Likewise, it will be henceforth called: Ornamental Electrical Molding System to the whole system comprising the Electrical Molding and all the Complementary Components in generic form; Ornamental Line to a specific subset of such System, comprising an Electrical Molding and the corresponding Complementary Components, where all its components share the same aesthetic features (shapes, textures, colors, etc.); Electrical Molding to the molding in itself; Architectural Cables to the whole set comprising the cables used for electrical or telephone installations inside buildings and to all the electrical devices that complement such installations; Architectural Moldings to the group of elements, including the moldings and the traditional profiles that are used for the decoration of urban buildings, when they are decorated with traditional moldings.

Since the system of Ornamental Electrical Molding results from combining the electrical functions of the architectural cables and the ornamental and aesthetic features of the moldings, its use as a product is that of a complement of both systems (the system of traditional architectural cables and the system of traditional architectural moldings). The adjustment of the Ornamental Electrical Molding System to the mentioned systems requires its manufacturing in a great range of Ornamental Lines so as to cover the different architectural styles with which the system has to combine its design. This requirement increases the investment in matrices. The Interconnection Module, object of this patent, tries to solve this problem by systematizing the components of the system so as to avoid repetitions and inefficiencies that unnecessarily increase the production investment.

### BRIEF SUMMARY OF THE INVENTION

The Interconnection Module is an electrical interconnection unit that functions as an interphase and that is a structural part of the Complementary Components, which, together with the Ornamental Electrical Molding (U.S. Pat. No. 5,367,122), form a functional system used for ornamental electrical installations on surface.

### DETAILED DESCRIPTION OF THE INVENTION

Purpose

The “Interconnection Module” is the result of both the systematization of the functions that fulfill the group of Complementary Components and the classification and rationalization of the elements that constitute each of such Complementary Components. The purpose of this is the simplification of the design and the production, trying to get the highest quality at the lowest price.

Need of a Practical Order

The functions that the Ornamental Electrical Molding has to perform explain the needs for the Interconnection Module.

As mentioned before, the Ornamental Electrical Molding as a system is based on the existence of the system of Architectural Cables and the system of Architectural Moldings; it is supported by both systems and it complements them.

However, despite having the electrical functions of the cables and the aesthetic shapes of the moldings, the Ornamental Electrical Molding differs substantially from both products.

The relation of reciprocal complementarity among these three systems is based on the differences that characterize each one. The characteristics that differentiate the Ornamental Electrical Molding system from the other two systems determine the features of the Interconnection Module.

The Ornamental Electrical Molding system is based on the existence of the Architectural Cables system. This is so because none of the electrical installation performed with the Ornamental Electrical Molding system whose purpose is to carry out small supplementary installations can have either the scope or the complexity that an installation performed with the system of Architectural Cables can have. On the contrary, when using the Ornamental Electrical Molding system to make a supplementary installation, it is supposed that an installation performed with the Architectural Cable system preexists.

The Ornamental Electrical Molding system functions as a complement to the preexisting installations; it covers those aspects that the Architectural Cable system does not provide.

Thus, the Ornamental Electrical Molding system within the context of installations in buildings is a “system for supplementary electrical installations” whose function is to regulate the changing needs of the electrical services in urban buildings, supplementing the limitations of the Architectural Cable system in these cases.

This possibility is created by the permanent changes of everyday life that produce variations in the needs related to the use and arrangement of the spaces. These changes modify the requirements of the telephone or electrical services, which can not be easily solved with the systems of traditional cables used for more “permanent or rigid” installations and for installations that are generally situated within the walls of the building.

In brief, the Ornamental Electrical Molding system would allow to complement the permanent installations situated within the walls of the building and performed with the Architectural Cable system. It would act as a system for supplementary electrical installations that is easy to mount and dismount and that can adjust its design to the existing decoration, thus fulfilling the requirements created by the changes in needs.

On the other hand, the Ornamental Electrical Molding system and the Architectural Molding system depend on each other. This dependence is based on the basic principle that applies to the decoration with moldings. Such principle, many times applied intuitively, implies that “the main moldings in a decoration must be complemented with moldings or profiles of less importance so as to balance the effect of the main moldings”. It is on this principle that the relationship between the Ornamental Electrical Molding system and the Architectural Molding system is based.

In this case, the Ornamental Electrical Molding system would act as an “Accessory Molding” complementing the Architectural Molding system by emphasizing its special features and supplementing its functions in a twofold manner:

1—As an auxiliary molding. In addition to complementing the main moldings of the Architectural Molding system adjusting its design, it can offer additional electrical services in decorated spaces, a feature that the profiles of the Architectural Molding systems do not offer. It fulfills in this case the function of “supplementary electrical installations” used to cover the electrical services originated by the change in the needs.

2—In general, the use of Architectural Moldings aims to give importance to the spaces, changing flat surfaces into others full of shapes and movement. The result produced by the moldings becomes apparent through the adequate effect of light and shadow that stresses its volumes and shapes. This is only produced by an adequate lighting. Because of this, the Ornamental Electrical Molding system is transformed into the ideal complement to the Architectural Molding system, thus giving it the necessary lighting together with the complementary effect of an accessory molding.

This relationship of complementarity among the three systems, i.e., on the reciprocal compensation of its strengths and weaknesses explains the reason for the need of the Interconnection Module.

In other words, what make these systems complement one another are the differences among them.

The cables in the Architectural Cable system are not intended for external use because its “shape” does not satisfy decoration needs. Their shape, generally circular, allows their easy sliding within embedded tubes in the walls or along cable

On the contrary, the “shape” in the Ornamental Electrical Molding system, as its name implies, represents its main and distinguishing element. But that is not all; such a “shape” depends on the architectural style to which it has to adjust and with which it has to combine its design.

Since its “shape” is a distinguishing element and since it has to adjust itself to a great number of designs, this system needs to be offered to the market in a great variety of styles; that is to say, in a great variety of Ornamental Lines.

This great variety of styles required from the Ornamental Electrical Molding system generates a greater demand in the investment of required matrices. This is the most relevant aspect in the production investment and it represents the main fixed cost of each new design, and thus, of each new Ornamental Line. Thus, there is a need to reduce the incidence of the investment in matrices that this demand produces.

In brief, the complementarity relation among the Ornamental Electrical Molding system and the Cable and the Architectural Molding systems determines the need of a great variety of models with different aesthetic designs. This variety in models increases the investment in matrices. To reduce the investment is what justifies the need of the Interconnection Module. On the other hand, the differences among the Electrical Molding system and the other two systems that it complements, synthesized in the features of the Ornamental Electrical Molding system, are what determine the elements that comprise the Interconnection Module.

The Interconnection Module solves the problem of investment in matrices limiting such investment only to the components that change with each new Ornamental Line. Thus, the fixed costs of the launching of each new line are reduced so that they can be rapidly absorbed by a small quantity of units sold. In this way, the balance in the investment can be reached.

Advantages:

The purpose of the Module is to standardize common functions in different ornamental lines of this system so as to:

1—Considerably reduce the fixed costs produced by launching new models, with which the necessary quantity of units to cover them is reduced, thus eliminating the investment risk.

2—Systematize the production design.

3—Accelerate the changes in the design to adjust them to the market needs.

4—Reduce the costs in matrices.

5—Reduce the costs of stock to manufacturers and distributors by allowing to have at their disposal many units of Complementary Components with different designs and a lower quantity of modules that are common to those components.

6—Cover a great variety of tastes and styles with a small investment.

7—Lower the prices to the buyers.

8—Reduce the impact of the changes in styles or preferences on the investment.

9—Develop multifunctional modules that allow covering the functions of different types of accessories.

10—Allow the adjustment of the standard products preexisting in the market; for example, light fixtures; such module would act as interphase between the Ornamental Electrical Molding and such products. In other words, the Ornamental Electrical Molding could function as an interphase to which other familiar products can be connected through fixing elements, thus transforming those products into components of the Ornamental Electrical Molding system.

11—Allow to guarantee safe connections by means of a Connection Guide, thus ensuring only one possible position of the Molding and forcing the centre of the Pins of the Interconnection Module to coincide with the centre of the tubular conductors of the molding.

12—Allow to divide the manufacturing process, which can be achieved through an Interconnection Module with standard dimensions. On the one hand, the manufacturing of such modules with standard dimensions offered to the market by certain companies. On the other hand, the manufacturer of electrical installation products or of moldings could only manufacture the Molding and the Molded Boxes, adjusting such parts to their specific products and buying the standard parts to the first ones.

Resources to Solve the Problem

The particular characteristics of the Ornamental Electrical Molding system determine the components of the Interconnection Module. Because of this, it is necessary to analyze the effects of such characteristics on determining the form of such Module.

This analysis is done in two ways:
A) On the one hand, the Ornamental Electrical Molding system in itself is analyzed. This analysis has three purposes:
   1—To determine the impact of each of the components that constitutes the Ornamental Electrical Molding system in the production investment.
   2—To specify the elements that are part of the structure of the Complementary Components.
   3—To synthesize the needs that result from the previous points and support the creation of the Interconnection Module.
B) On the other hand, the Ornamental Electrical Molding system is analyzed in relation to the characteristics that differentiate it from the products it complements. This analysis aims to specify the elements that will form the Interconnection Module and to understand why they are part of this Module.

A1) Now consider the constituent parts of the Ornamental Electrical Molding system so as to be able to determine the way in which they influence the production investment.

As mentioned before, the basic constituent parts of the Ornamental Electrical Molding system are the Electrical Molding in itself and the Complementary Components.

It is important to take into account that each new Ornamental Line consists of a new system comprising both an Electrical Molding and a subsystem of Complementary Components (Connectors and Fittings) with similar characteristics of design.

As regards the Electrical Molding, its changing part is the shape of its external profile. The use of a die or extrusion matrix allows to get such external profile. Such matrix slightly influences the production investment because it is very simple and because only one is required since it is a single component within the system of each new Ornamental Line.

It does not happen the same with the Complementary Components. For each change in the Ornamental Line there is a great number of Complementary Components since they represent a new subsystem that must be adjusted to the new design.

The subsystem of Complementary Components produces the greatest influence in the increase of the production investment created by the addition of new Ornamental Lines.

This makes necessary the careful analysis of such Complementary Components because their systematization can greatly reduce the investment in matrices.

A2) From the analysis of their constituents parts it can be derived two basic categories of constituent elements: a) those elements that are inherent to the Complementary Components in the sense that they represent the parts that constitute their essence, and b) those elements that are not inherent to the Complementary Components, they are added to them and supplement their services. That is to say, the Complementary Components are formed by inherent elements and by elements that are not inherent. The not inherent elements are already existing products that add their functions to the Components. For instance, the Supplementary Devices are parts of the Electrical Fittings which, in turn, are part of the Complementary Components.

“Constituent Elements” will make reference to any of the parts that constitute the Complementary Components. “Inherent Elements” will refer to those constituent elements that are inherent to the Complementary Components no matter whether they are Connectors or Fittings and regardless of the Ornamental Line.

Within the system integrated by the Molding and the Complementary Components of the same Ornamental Line, all the components share the same style. Within the subsystem of Complementary Components, a wide variety of these would exist, all of them functionally different but aesthetically similar. These functional differences can be obtained with different combinations of Constituent Elements.

The Complementary Components that perform the “same function” within “different Ornamental Lines” share the same combinations of Constituent Elements. Thus, the Complementary Components of different Ornamental Lines that perform the same function in each of the lines differ in their aesthetic design.

In turn, there are elements among the Inherent Elements that, though they can be different morphologically, they perform similar functions in different Complementary Components of the same Ornamental Line. These will be referred to as Generic Elements.

A3—The change in style from one line of products to another determines another category within the Generic Elements that constitute the Complementary Components. The elements in this category are, on the one hand, those that do not change with variations in the ornamental design and, on the other hand, those that are modified with each new style.

The Interconnection Module results from standardizing combinations of elements which behave in similar ways in different designs so that they can be used in any Ornamental Line.

For this standardization, the elements that do not change from one design to another are isolated and separated from those that change from one design to another. The additional investment in matrices is limited to the latter elements.

As a result of these considerations, there is a need to create a component that synthesizes all the Inherent and Generic Elements of the Complementary Components, but separating the changing aspects from those that are invariable. This causes the creation of the Interconnection Module.

Thus, the Interconnection Module results from:

a) abstracting the Generic Elements in the Complementary Components.

b) systematizing those functions that are fulfilled combining the Generic Elements in the same way.

c) separating the changing aspects among models from those that are invariable and grouping each of them in a different part of the module.

B—To specify the parts that will form the Interconnection Module and understand their function, it is necessary to analyze the relevant differences between the Ornamental Electrical Molding system and the existing products to which the Ornamental Electrical Molding complements.

B1—First, the basic electrical functions will be considered. The difference between the Ornamental Electrical Molding system and the system of Architectural Cables will be analyzed in terms of the way in which the connections between different circuits (bridge or bypass) are made in one system and in the other. (“Bypass or bridge” refers to all of those “relations” that are produced between circuits of an installation and that allow the functional integration between them).

All the bridges and interconnections among circuits in the system of Architectural Cables are generally made with the same cables. That is to say, the traditional cables fulfill two functions: 1) they conduct the electricity or the electrical signals to the different required places, and 2) they establish the interconnections between circuits (bridge or bypass) according to the requirements of the circumstances. The circuits in the system of Architectural Cables are not planned beforehand since they are established according to the needs of each installation and through the simple joint of cables.

On the contrary, in the Ornamental Electrical Molding system, the Molding itself only conducts the electricity or signals where it is required, and the interconnections between circuits are established through accessory circuits added to the Complementary Components in a predetermined way.

The circuits within a Complementary Component can be very simple. For example, within the group of Connectors that are part of the Complementary Components, “a bend”, used to deviate the course of the molding, or a “T”, used to branch that course, has a very simple circuit. On the contrary, a device with several sockets or switches can have circuits of greater complexity, in which the combinations required by the functions are produced.

In general, it can be stated that all the Complementary Components have at least one accessory electrical circuit, which can be either basic, with only one electrical element or greatly complex, with several electrical elements of different characteristics. All these circuits are predetermined.

Thus, the interactions in the installations of the Ornamental Electrical Molding system are solved through the creation of predetermined accessory circuits that are planned in a standard way and used according to the needs of each situation. These are elements that do not change with variations in Ornamental Lines.

These accessory circuits can comprise diverse types of Electrical Elements. Such Electrical Elements vary according to the function that they have to fulfill. Four types of Electrical Elements can be generically defined.

a) First, these accessory circuits need to interact with other components that do not belong to the Complementary Component of which the Interconnection Module is part. This relation is done through the External Connectors, which are devices of different characteristics that allow to ensure the contact between the parts that they connect. An example of these are the pins through which the Module relates to the Molding itself.

b) In addition, the Interconnection Module may need to relate electrically to other parts of the same Complementary Component of which it is part, for example, to the Supplementary Devices that are part of the Complementary Component but not of the Interconnection Module. This function can also be performed by devices with different characteristics that allow to ensure the contact between the parts that they relate. These devices will be called Internal Contacts.

c) The External and Internal Contacts may need to relate between each other; this relation will be fulfilled by the Intercontacts.

d) Finally, in certain cases, due to the simplicity of the Complementary Component or due to convenience, electrical elements with multiple functions can be used, thus totally or partially covering the functions of the other three elements. These Electrical Elements will be called Hybrid Electrical Elements.

B2—If the analysis to identify other Generic Elements is continued, it can be said that these predetermined auxiliary circuits require an insulating base that, in turn, is the material base that holds and integrates the other elements. The solution to this is a component that will be the “Insulating Body” which will contain the Electrical Elements responsible for the electrical interactions within the Ornamental Electrical Molding system. The Insulating Body will also adjust its shape to the requirements of each Complementary Component of which it is part.

B3—Substantial differences arise from the analysis between the Ornamental Electrical Molding system and the system of Architectural Cables. These differences are in relation to the way of performing the joints among the conductors in one system and in another and they allow to infer another necessary Generic Elements.

In the system of Architectural Cables two cables are joined through binding, soldering or through setscrew of cables. The special features of the joint methods in the system of Architectural Cables hinder their manufacturing with ornamental external shapes because the joints would affect the aesthetic continuity.

On the contrary, in the Ornamental Electrical Molding system the joints are performed through a socket between a tubular conductor and a cylindrical connector (pin). This makes that the cut in the joint point does not alter the morphological continuity of the molding, thus not deteriorating it aesthetically.

This joint, performed with certain pressure, is excellent since a clamping effect between the conductor tube and the pin is produced. This pressure is exerted by introducing the cylindrical connector pin of a slightly greater diameter than the internal diameter of the conductor tube of the molding, thus producing a slight elastic resistance. This ensures an excellent contact between the conductor tube and the connector pin. The pins (male connectors) are fragile elements that can be twisted if they are forced into an inadequate position which must be avoided so as not to affect the quality of the joints. The correct insertion of the pins is determined by an adequate position of the molding regarding the contacts (pins) of the Complementary Components with which it connects. This is determined by the adequate alignment between the axis of such male connector (pin) and the axis of the conductor tube of the molding at the time of the joint.

That is to say, to perform this connection adequately, the axis position of the cylindrical pins must be concentric with the axis of the conductor tubes of the Molding.

This is solved by creating a “Connection Guide” that ensures that the axis of the conductor of the molding and of the connector of the Complementary Components (pins) are properly aligned at the time of performing the connection. Such guide must have an internal shape adjusted to the external shape of the molding. This is another Generic Element but it changes from one design to another.

B4—Another aspect to consider is the effect produced on the Complementary Components when the Ornamental Electrical Molding system must change its design from one Ornamental Line to another so as to adjust itself to the different styles of Architectural Moldings. Such changes in the design influence the Complementary Component in two ways and from such considerations arise new aspects about the Generic Elements.

In this sense such changes are:

a) In the external shape of the Complementary Components which combines with each design.

b) In the shape of the Connection Guide that is affected by the changes in the external shape of the Electrical Molding.

This can be solved by grouping the elements that change from one Ornamental Line to another in a section of the Interconnection Module called “Molded Box” which will be the external covering of the module. In addition to having the same external shape according to the design, this external covering will be able to add one or more “Connection Guides” with the adequate shape of the molding so as to perform the correct connection.

B5—Finally, since it may be necessary to adjust or modify the function of the accessory circuits for practical reasons, such circuits, made up of previously mentioned Electrical Elements, may add Electronic Elements. These Electronic Elements are products that already exist in the market through which it may be possible to add functions such as line filtering, stabilization, amplification, etc.

There are five Constituent Elements that are inherent to the Complementary Components which can be considered Generic: Insulating Body, Electrical Elements, Molded Box, Connection Guide and Electronic Elements. The total or partial interaction between these would cover the functions that such Module aims to fulfill.

As mentioned before, there is one group of elements within the Constituent Elements that is also part of the Complementary Components but, as it is not inherent to them, it will neither be part of the Interconnection Module nor be considered generic. Those elements are the Supplementary Devices. These are already existing products that give a specific function to such Complementary Components. Examples of these products are switches, sockets, Jack RJ11, etc.

Thus, it is possible and convenient to group the Generic Elements that constitute the Interconnection Module, separating those that vary with changes in the design from those that do not vary and assigning each of them to a different part of the Module.

As a result from this synthesis, there are invariable elements represented in the Insulating Body with the elements that it contains, and represented in the Molded Box there are those elements that change with variations of models. Thus, the additional investment in design and matrices that represents the launch of new Ornamental Lines will only be limited to the part of the module that will vary with those lines, that is to say, to the Molded Box. The Molded Box will be the part of the Module with the lowest production cost.

It is possible to significantly reduce the investment in matrices, stock and distribution required by this product. This can be achieved by systematizing the Generic Elements in such a way that they can be standardized through the Interconnection Module and that the Interconnection Module can be considered an interchangeable part of the Complementary Components.

This allows the rapid recovery of the investment in new ornamental lines, that is, with few sold units, thus making the investment more profitable.

Besides, this allows splitting the production process into two stages and distributing them in such a way that the process is more convenient economically.

The resulting Interconnection Module is an electrical unit that can be either an undivided and undifferentiated part or an independent and interchangeable part in the structure of the Complementary Components.

Functional Relation Between the Parts

As mentioned before, the Interconnection Module results from: abstracting the elements that are inherent to the Complementary Components as Generic Elements with regard to the functions that they fulfill in each Ornamental Line and systematizing them by grouping in the “Insulating Body” those Generic Elements whose shapes and combinations “do not vary” from one Ornamental Line to another and by grouping the changing morphological aspects in the Molded External Box.

Thus, the Interconnection Module is an electrical unit that functions as: 1) an interphase that allows the electrical connections of different sections of the Electrical Ornamental Molding between each other or that allows the connection of the Molding with the Complementary Components or of these components among each other and 2) an interphase between the molding and other already existing elements.

As mentioned before, this Interconnection Module as an electrical unit can be considered an undivided part or an independent, separated component in relation to the structure of the Complementary Component. In the latter case, the Interconnection Module is an interchangeable element among different models with identical functions but different design.

In brief, the Generic Elements of the Interconnection Module are the followings:

a) the Insulating Body

b) the Electrical Elements

c) the Molded Box

d) the Connection Guides

e) the Electronic Elements.

a) The Insulating Body is the base of insulating material in which the Electrical Elements and eventually the Electronic Components are incorporated. This body can also hold the Fixing Elements that can be external or internal. An example of an external fixing element is the adhesive foam band used to fix such module to an external surface. The internal fixing elements would allow that the following items are held to the Insulating Body: the Molded Box and/or other parts of the Complementary Components of which the module is part, such as the Supplementary Devices and/or other devices that already exist in the market with which such Module functions as interphases with the molding.

Besides, the area of the Insulating Body where it is linked to the Electrical Molding can have one or more Connection Guides.

b) The Electrical Elements can be: a) External Contacts, b) Internal Contacts, c) Intercontacts and d) Hybrid Electrical Elements.

The External Contacts (1.1), (2.1) and (3.1) are used to connect such Module to other elements that do not belong to the Complementary Component of which such Module is part and with which such Complementary Component functionally interacts, for example, with the Ornamental Electrical Molding, or with other Complementary Components or with other external devices that do not belong to the patented group. The Internal Contacts (2.2) are devices that allow joining such Module to other parts of the same Complementary Component of which it is part. Examples of those parts are the contacts of the Supplementary Devices, such as a Jack RJ11 (2.4), which, together with the Module, can be part of the Electrical Fittings. The Intercontacts are used to join internal and/or external contacts between each other (1.3), (2.3) and (3.3). The Hybrid Electrical Elements (4.1) are electrical elements with multiple functions. They can fulfill the functions of the external contacts and/or of the internal contacts and/or of the intercontacts respectively.

c) The Molded Box is the covering of the Interconnection Module which gives it the required functional and ornamental finish. It is the part that synthesizes the design changes that influence the Complementary Components. It can also have internal or external fixing elements and one or more connection guides. The internal fixing elements allow it to adhere to the Insulating Body and/or to the Supplementary Devices. The external fixing elements give adherence to elements that are external to the Complementary Component. The Molded Box can be a separate and differentiated element and, thus, an independent part of the Interconnection Module. But if it is required, it can be integrated into the Insulating Body as an undivided part with it.

d) The Connection Guide. It is a cavity with an internal shape similar to the external shape of the Electrical Molding. It is used to achieve the concentricity between the axes of the cylindrical male connectors of the Module and the tubular female connector of the Molding so as to ensure a precise interconnection.

The external contacts of the module (pins) will be found inside the Connection Guide; the module will be linked to the Electrical Molding through these contacts. Such Connection Guide will direct the Molding in the process of connection, thus ensuring that it occupies a unique possible position inside the Module and allowing that the axes of the cylindrical contacts of such module (pins) coincide with the axes of the tubular conductors of the Molding.

e) The Electronic Elements. The Interconnection Module can have Electronic Elements in its structure to complete its functions. Examples of these components are variable resistances, stabilization or filter circuit, etc. These elements are found in the market and will be added when there is a need to adjust or improve the electrical characteristics of the system.

### BEST WAY OF CARRYING OUT THE INVENTION

The best way of carrying out this invention is by using already existing equipment, without investing in fixed assets. Due to the simplicity of this product and to its little technological requirements, it is possible to take advantage of existing equipments and installations of the Cable and Plastic industry without investing in machinery and by limiting such investment to the matrices required by the different models.

Such investment in matrices is made up of an initial investment in those permanent components within the system and an additional investment that depends on the new Ornamental Lines incorporated. This offers better opportunities for those that manufacture for a third party that can recover the initial investment in matrices more rapidly creating standard sizes.

Thus, the Interconnection Module allows the division of the production. On the one hand, for those that provide such modules manufactured under accepted standards. On the other hand, those companies of the markets whose products are complemented by the Electrical Molding such as the Cables and Architectural Moldings, which only manufacture the Molding and the Molded External Boxes adjusting them to the design of their own products with which the investment in new ornamental lines will be rapidly recovered.

### INDUSTRIAL APPLICABILITY

As mentioned before, this product is designed because of a specific need of the market of Cables and Architectural Moldings. It aims to offer the possibility of making “supplementary installations”, a need that is not satisfied by the system of traditional cables. Thus, it seeks to solve the changes in the requirements of electrical services that produce the variations in the arrangements of the architectural spaces. On the other hand, it aims to satisfy the needs of the market of the architectural moldings functioning as an auxiliary molding, adjusting its design to the main moldings and fulfilling two functions: to provide the electrical services where it is required, and to provide the necessary lighting of the system of traditional moldings so as to emphasize its decorative shapes and effects through the effect of lighting and shadows.

### BRIEF DESCRIPTION OF THE SEVERAL VIEWS OF THE DRAWINGS

The FIGS. 1C, 2C, 3C and 4C show diagrams of Complementary Components with the Molded Boxes that give them the right finish according to its specific function. The Connection Guides can be observed in the boxes. FIGS. 1C and 2C are Electric Fittings and FIGS. 3C and 4C are Connectors.

To specify:

FIG. 1C represents an Electric Fitting with different female sockets.

FIG. 2C represents another type of electric fitting: a box for a telephone connection that includes a Jack RJ 11 as a Supplementary Device.

FIG. 3C shows an interconnection plug used for connecting an electrical molding with juxtaposed conductors and this with another Molding where the conductors are concentric. This plug is used to join connections that cross walls.

FIG. 4C shows a flat angle to deviate an installation to 90 degrees.

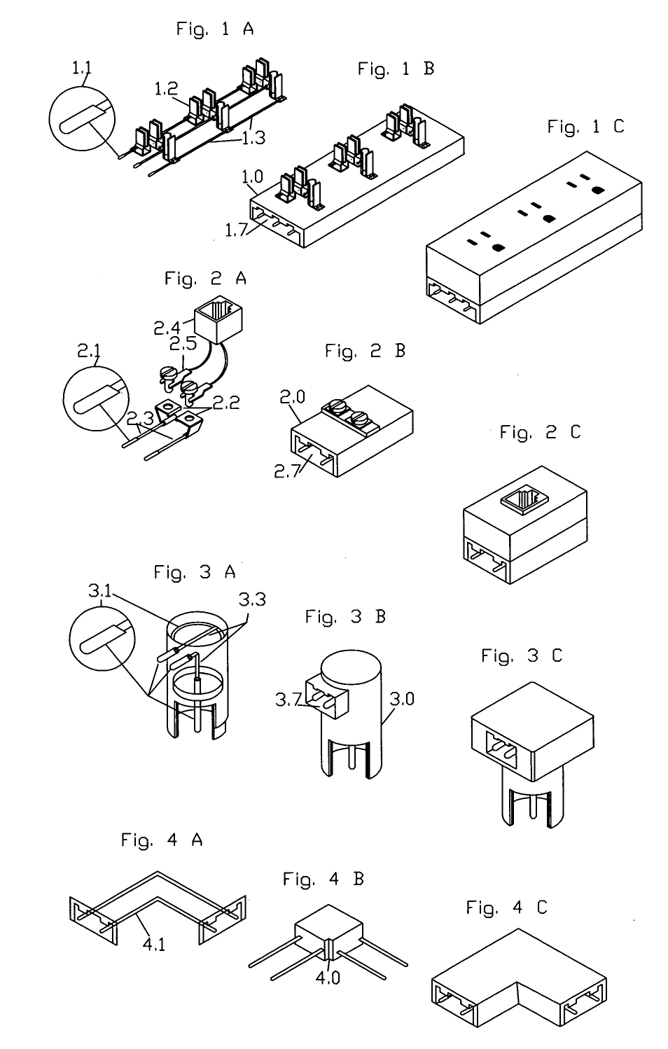

FIGS. 1B, 2B, 3B and 4B show diagrams of how the Interconnection Modules themselves could look like outside the Complementary Component that they integrate.

In FIGS. 1B, 2B, 3B and 4B, the indicators (1.0), (2.0), (3.0), (4.0) respectively show the Insulating Body of the Interconnection Module. In addition, the indicators (1.7), (2.7) and (3.7) of FIGS. 1B, 2B, 3B respectively show the Connection Guide.

FIGS. 1A, 2A, 3A and 4A show diagrams of the electrical elements that make up an interconnection module.

FIG. 1A is made up of the External Contacts (1.1) and Intercontacts (1.3).

FIG. 2A is made up of External Contacts (2.1), Internal Contacts (2.2), and Intercontacts (2.3) in addition to a Supplementary Device (Jack RJ11) (2.4) and its own contacts (2.5).

FIG. 3A is made up of External Contacts (3.1) and Intercontacts (3.3).

FIG. 4A only has a Hybrid Electrical Element (4.1) which, in this case, functions as external contact and intercontacts.

Preamble:

The Ornamental Electrical Molding patented in U.S.A in Nov. 22, 1994 with the U.S. Pat. No. 5,367,122 is the main element of a system consisting of the molding itself and the Complementary Components; such Complementary Components consist of the Connectors whose purpose is to facilitate the joints, deviations and branches of different sections of the molding and of the Electrical Fittings whose purpose is to expand the specific functions of the Ornamental Electrical Molding system; the Interconnection Module is a part of such Complementary Components, it can be an undivided part or a separate and independent part of them; such Interconnection Module arises from abstracting and standardizing electrical functions that are common to different models of such Complementary Components that are intended for the same aim so as to systematize its design and manufacturing.

1) An Interconnection Module that is a structural part of the Complementary Components, which together with the Ornamental Electrical Molding (U.S. Pat. No. 5,367,122) form a functional system, intended to be the interface between the system components; such Interconnection Module is characterized because it could be structurally an undivided and undifferentiated part or a differentiated, separated and independent part regarding the Complementary Components that it integrates, in both cases the Module is completely and functionally integrated to the Complementary Component of which it is part; said Interconnection Module is also characterized by comprising at least one Electrical Element that will give its function of electrical intermediary and of at least one Insulating Body that will be the material and insulating base of such Electrical Elements; said Modulo is also characterized because it can include in its structure a Molded Box which will be the external element that gives the Module its ornamental shape, this Molded Box may be differentiated or not as an independent component regarding the Insulating Body; said Interconnection Module may also have one or more Connection Guides; and said Module could include one or more Electronic Elements that would complement the electrical function, these elements are existing products which are not claimed as such.

2) An Interconnection Module, as the one claimed in claim (1) where the Connection Guides are holes intended for ensuring the right position of the Electrical Molding with respect to the Interconnection Module so as to achieve the concentricity between the axes of the cylindrical external connectors of the Module (pins) and of the female tubular connectors of the Molding, said Connection Guides are characterized by being cavities with their internal shape that match with the external shape of the Electrical Molding.

3) An Interconnection Module, as the one claimed in claim (1) where the Insulating Body and/or the External Molded Box are characterized because they could include External Fixing Elements which allow fixing such Module to the external objects it adheres; and/or Internal Fixing Elements characterized by allowing the fixing between the constituent parts of the same Interconnection Module or between the Module and the Complementary Components of which it is part; such Insulating Body and/or such External Molded Box may also have one or more Connection Guides.

4) An Interconnection Module, as the one claimed in claim (1) where the Electrical Elements are characterized because they could be Internal Contacts which are devices that allow joining such Module to other parts of the same Complementary Component of which it is part; External Contacts which are devices that allow the electrical connection of such Module to other elements that do not belong to the Complementary Component of which such Module is part and with which such Complementary Component functionally interacts; Intercontacts which are devices that allow the electrical connection of the Internal Contacts between each other and/or External Contacts between each other and/or Internal and External Contacts between each other; Hybrid Electrical Elements, which are devices that can perform the functions of the External and/or Internal Contacts and/or Intercontacts respectively.
